(19) United States
(12) Patent Application Publication
(10) Pub. No.: US 2010/0102934 A1
(43) Pub. Date: Apr. 29, 2010

(54) Onboard System for Identifying and Monitoring the Content of an Aircraft

(75) Inventor: Philippe Guichard, Chabeuil (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly Sur Seine (FR)

(21) Appl. No.: 12/580,050

(22) Filed: Oct. 15, 2009

(30) Foreign Application Priority Data
Oct. 24, 2008 (FR) 08 05919

(51) Int. Cl. H04Q 5/22

(52) U.S. Cl. 340/10.42

(57) ABSTRACT

The object of the invention is to allow exhaustive knowledge of the previously marked contents of an air transport means. The invention thus consists of a system for identifying and monitoring the set of the elements belonging to the content of a transport aircraft (V) allowing the user to ascertain in real time the content of said transport aircraft (V).

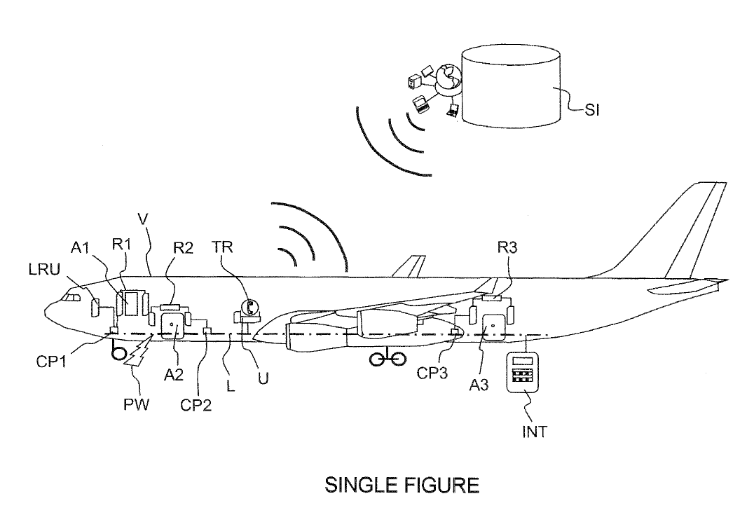

It relies notably on the use of means of remote reading (R1,R2,R3), such as RFID readers, positioned so as to form a portal at the level of at least one of the access doors (A1,A2,A3) of the transport aircraft (V), capable of acquiring the identity of the set of the elements entering or exiting said transport aircraft (V), and it is characterized by the fact that the power supply means and the communication means used by the system according to the invention can utilize the power supply and communication networks of the aircraft (V) which are designed to operate solely when said aircraft (V) is on the ground.

### PRIORITY CLAIM

This application claims priority to French Patent Application Number 08 05919, entitled Onboard System for Identifying and Monitoring the Content of an Aircraft, filed on Oct. 24, 2008.

### FIELD OF THE INVENTION

The present invention relates to the field of air transport means. More precisely, the device according to the invention is an onboard system for identifying the content of an aircraft.

### BACKGROUND OF THE INVENTION

The object of the invention is to allow exhaustive knowledge of the previously marked contents of an air transport means. The invention consists of a system for identifying and monitoring all the previously marked elements belonging to the content of said air transport means, guaranteeing the total absence of any disturbance to the flight systems.

In the present document, the term “marked” signifies “bearing a mark” (or “tag”) of AID type (the acronym standing for Automated Identification) or RFID type (the acronym standing for Radio-Frequency Identification).

It is important for an aircraft operator to precisely ascertain the content of the latter. The term content is intended to mean in a non-exhaustive manner: passengers, crew members, maintenance personnel, luggage, cargo commercial payload, contents such as catering resources or duty-free sales, as well as the aircraft's component hardware. This knowledge makes it possible to satisfy several functions:
flight safety and management for the human content,
guarantee of the proper transit of the luggage,
guarantee of the proper transit of the cargo payload,
guarantee of the appropriateness of the catering and sales resources,
guarantee of the configuration of the components of the aeroplane.

For example, in respect of luggage, the poor orientation of a piece of luggage can cause a delay for the passenger or a complete loss of this luggage, giving rise to a high cost for the majority of operators or airlines.

Numerous known projects making it possible to ensure content knowledge concentrate on the formulation of “ground” identification systems, that is to say ones that are not onboard, on the one hand, or onboard identification systems on the other hand.

Known systems exist, such as that described in patent US2002089434, for allowing the identification of a vehicle's content in terms of merchandise and persons; these systems are described as applicable to aerial vehicles. However, they exhibit a major difficulty, the solution to which is the object of the present invention, the said difficulty hitherto preventing operational use of the systems described in said patent: this difficulty resides in the complexity of demonstrating non-disturbance to the flight-critical systems. Currently, this drawback gives rise to the non-certification for flight of such systems.

Other known systems allow the identification of the components of an aircraft, such as that described in patent PCT/US2006/036873. Systems of this type are dedicated to the aircraft's components, and do not include any onboard system for reading and transmitting the onboard information: they are intended only for maintenance operations.

Moreover, other known systems exist in the “ground systems” category, that is to say ones for which all the components of the device are on the ground, and not onboard the aircraft.

It should be noted that the term “certification”, used in the present description and in the claims, pertains to the certification for commercial flight authorization granted by the public authorities in charge of said aircraft authorizations, such as the “Federal Aviation Administration”—FAA—in the United States, or “the European Aviation Safety Agency”—EASA—in Europe.

“Ground” systems exhibit several major drawbacks, related notably to difficulties of implementation. For example, their installation can turn out to be complex and expensive, notably within the framework of uses in contexts that are independent of the aircraft: mention may be made of the case of aircraft access linkways in airports, which belong to the airport and are used by several airlines. Moreover, these systems exhibit the defect of requiring that each of the aircraft's destinations be equipped with said “ground” systems. Finally, “ground” systems cannot guarantee the content of the aircraft with certainty since elements can pass through the “ground” system and not reach the access door of the aircraft, or emerge through another door of the aircraft which does not correspond to a detector of the “ground” system.

The known onboard systems exhibit the significant drawback of giving rise to a cost overhead when certifying equipped aircraft, notably for civilian transport aircraft, in particular in the case where they have to use resources of said aircraft that are useful for flight, these resources being in fact critical for the safety of the aeroplane and of its occupants.

In the subsequent description and in the claims, the expression “power supply” is understood to mean an electrical energy conversion or distribution device.

For example, if such an identification system of known type uses as energy source a common power supply shared with any one of the flight systems, then all the precautions and all the constraints of said flight system with regard to said power supply are applicable to the identification system, rendering the certification process very lengthy and very expensive, on account notably of the demonstration of non-disturbance which must be afforded during the certification process.

This demonstration of non-disturbance is all the more indispensable in the case where the identification means which form part of the identification device call upon radio-frequencies, liable to interfere with the flight systems.

The subject of the invention is consequently a system allowing the identification of the elements entering and exiting a transport aircraft, whether these are persons or objects, such that it makes possible the real-time knowledge, by the computerized system of the user of said system, of the content of the transport aircraft, and such that its installation on said transport aircraft requires only a minor supplement to certification, not involving demonstration of non-disturbance to systems that are critical for the safety of the aircraft, this latter point making it possible to alleviate the major drawback of the technique of the aforementioned prior art. Solving this problem is the main objective of the device according to the invention. The characteristics of the device according to the invention make them possible and certifiable on an existing aircraft.

A particular and known characteristic of aircraft is now described so as to describe the way in which the device according to the invention guarantees the absence of any feared, in the sense of certification, disturbance.

Known aircraft comprise systems termed “non-critical”, in the sense that they are not critical for flight security.

Some of these systems are designed and certified so as to be activatable only when the aircraft is on the ground. A known means for achieving the activation/deactivation of these systems is to condition their electrical energy supply to a signal called “weight-on-wheels”—to use the term of the art—which generally originates from a contactor on the landing gear.

The standards referenced by the FAA or those of the EASA may be consulted for the criteria which define such a system as being non-critical, activatable solely on the ground, and not a source of disturbance to critical systems. The only technical element referred to in the present description is that the activation of such a system is certified as being impossible in flight. In the description which follows, a device for conveying cargo containers into the hold of the aircraft is cited as an example: the motors which serve to move the loads are certified not powered in flight. There exist other systems in this case, like those used for operating the access doors, or the systems for transferring information by radio-frequency between the aeroplane and a transmitter on the ground at the level of a ground boarding gate. These systems serve notably for the maintenance data and for the in-flight entertainment video contents; mention may be made of for example GateSync™ from Thales™.

The invention consists of a system for identifying and monitoring the content of air transport means comprising portals at the level of the accessways of said transport means, which allow the remote reading of markers of AID type (the acronym standing for Automated Identification) or RFID type (the acronym standing for Radio-Frequency Identification).

### SUMMARY OF THE INVENTION

For this purpose, the subject of the invention is an onboard system for identifying and monitoring the content of an aircraft exhibiting at least one accessway, said aircraft comprising at least one pre-existing electrical device for a function other than that of the system according to the invention, making use, for its activation, of a power supply network designed and certified so as to be able to be powered up only when the aircraft is on the ground, said content consisting of a set of elements that can comprise objects and/or persons, each of said elements possessing an identity, said set of elements exhibiting a set of elements exiting, that is to say leaving the content of the aircraft, and a set of elements entering, that is to say joining the content of the aircraft, each of said elements comprising individual means of remote identification making it possible to ascertain the identity of said elements, said system comprising moreover:
a computerized system,
means of remote reading of said individual means of remote identification,
power supply means for said means of remote reading,
means of communication between said means of remote reading and said computerized system,
   the means of remote reading of said individual identification means ensuring the acquisition of the identity of the elements entering and the identity of the elements exiting, and communicating with the computerized system, so as to allow the ascertaining in real time of the identity of the set of the elements constituting the content of the aircraft, characterized in that said power supply means draw their energy from said power supply network, designed and certified so as to be able to be powered up only when the aircraft is on the ground.

Advantageously, said communication means are designed to operate solely when the aircraft is on the ground.

Advantageously, said communication means are of CPL type (the acronym standing for Communication on Power Lines). In this case, the physical communication channel or channels are merged with the physical energy supply channel or channels.

In a preferential embodiment, the aircraft comprising a pre-existing set of physical communications channels for functions other than that of the system according to the invention, and designed to be activatable only when the aircraft is on the ground, characterized in that the communication means of the system according to the invention use physical communication channels belonging to said pre-existing set of physical communication channels, with the exclusion of any physical communication channel.

Advantageously, the system according to the invention furthermore comprises means of inter-connection of said means of remote reading.

Advantageously, said individual means of remote identification comprise information relating to said elements.

Advantageously, the system according to the invention comprises specific means for informing in real time a user of said system of the identity and information relating to the elements entering or to the elements exiting.

Advantageously, at least one part of the communication means can be non-wired.

Advantageously, said individual means of remote identification are markers of AID type (the acronym standing for Automated Identification), i.e. “AID tags” as they are known in the art.

Advantageously, said individual means of remote identification are RFID markers (the acronym standing for Radio-Frequency Identification), i.e. “RFID tags” as they are known in the art.

Advantageously, said means of remote reading are adapted for reading one at least of the following types of AID markers: alphanumeric, barcode, contactless marker—such as RFID contact-based marker—such as memory card or memory button.

Advantageously, said means of remote reading are RFID readers (the acronym standing for Radio-Frequency Identification).

In an envisaged mode of implementation, said RFID readers possess at least one emitting and receiving antenna able to use one at least of the following frequency bands: low frequency LF, high frequency HF and very high frequency UHF.

Advantageously, the system according to the invention can possess a theoretical list of the elements entering comprising the identities of a set of elements assumed to have to join the content of the aircraft, and means for comparing between said theoretical list of the elements entering and said elements entering actually joining the content of the aircraft.

Advantageously, the system according to the invention can possess a theoretical list of the elements exiting comprising the identities of a set of elements assumed to have to leave the content of the aircraft, and means for comparing between said theoretical list of the elements exiting and said elements exiting actually leaving the content of the aircraft.

Advantageously, the system according to the invention comprises means for alerting a user of said system in the event of contradiction between the theoretical list of the elements entering and the elements entering actually joining the content of the aircraft.

Advantageously, the system according to the invention comprises means for alerting a user of said system in the event of contradiction between the theoretical list of the elements exiting and the elements exiting actually leaving the content of the aircraft.

Advantageously, the system according to the invention comprises at least one monitoring box comprising a screen making it possible to display images and texts.

Advantageously, the system according to the invention furthermore comprises portable means of remote reading, that can comprise power supply and communication supports.

Advantageously, the means of remote reading are fixed, disposed so as to form a portal at the level of at least one of the access doors of the aircraft.

Advantageously, the system according to the invention comprises processing units ensuring one at least of the following functions:

concentrator of data originating from the means of remote reading,
concentrator of data originating from the computerized system,
transmitter of data to the environment of the system,
transmitter of data to the computerized system (SI).

Advantageously, the power supply means comprise power supply couplers.

Advantageously, the power supply couplers are supplied by an energy source dedicated to the monitoring of the accessway or accessways of the aircraft.

Advantageously, the power supply means use one or more frequency bands not used by the aircraft for its inherent power supply.

Advantageously, the communication means use one or more frequency bands not used by the aircraft for its inherent communications.

Advantageously, the means of communications of the system according to the invention are of optical nature.

Advantageously, the system according to the invention moreover comprises means for transmitting energy between the constituent elements of the system according to the invention, said means for transmitting energy being preferably of optical nature.

Advantageously, the system according to the invention comprises a passenger monitoring box, notably for the passengers entering corresponding to said elements entering, and said passenger monitoring box indicates useful information to said passengers such as a position to be got to in the aircraft.

Advantageously, the aircraft comprising an in-flight entertainment system and passengers forming part of said content of the aircraft, the system according to the invention can comprise a link with said in-flight entertainment system, so that said in-flight entertainment system can access the identity of the passengers, with a view to offering them customized services.

Advantageously, the individual means of remote identification of the passengers entering are integrated into a boarding card.

Advantageously, the means of remote reading furthermore comprise means of remote writing allowing a user of said system to modify the individual means of remote identification.

Advantageously, said writing means are suited to one at least of the following AID markers: alphanumeric, barcode, contactless marker—such as RFID—, contact-based marker—such as memory card, or memory button.

### BRIEF DESCRIPTION OF THE DRAWINGS

Other characteristics and advantages of the invention will become apparent with the aid of the description which follows offered in relation to the appended single drawing which represents the schematic view of the onboard system for identifying and monitoring the content of an aircraft according to the invention.

### DETAILED DESCRIPTION OF THE INVENTION

The single FIGURE presents a diagram of the system according to the invention, represented, for illustrative purposes, within the framework of an installation on an aircraft V. This FIGURE represents a preferential embodiment, in which the pre-existing power supply network, designed and certified so as to be able to be powered up only when the aircraft is on the ground, and utilized by the device according to the invention is that of a device present in the hold of the aeroplane, such as the device for conveying containers.

The onboard system for identifying and monitoring the content of a transport aircraft according to the invention is therefore installed on an aircraft V. This aircraft V comprises three accessways A1, A2, A3, dedicated respectively to the entry/exit of passengers, to the entry/exit of luggage, and to the entry/exit of ancillary containers. Each accessway is equipped with means of remote reading of AID type (the acronym standing for Automated Identification), i.e. in this example RFID readers (the acronym standing for Radio-Frequency IDentification), respectively R1, R2, R3. Each RFID reader is equipped with antennas, preferably two for the RFID reader R1 situated at the passenger entrance and three antennas for the other readers. These antennas allow the RFID readers R1, R2 and R3 to communicate with one another or with their environment, on frequency bands that may belong to the low frequencies, to the high frequencies or to the very high frequencies.

Portable means of remote reading, i.e. for example portable AID readers, not represented in the FIGURE, can advantageously supplement the remote readers device. These portable AID readers preferably comprise power supply and communication supports. They furthermore comprise wireless communication modules, of WiFi type.

The function of the set of remote reading means, whether they be the RFID readers R1, R2, R3, or the portable AID readers, is firstly to allow the identification and the monitoring of the content of the aircraft V. Accordingly, each element of said content must be equipped with an individual means of remote identification, such as a marker, or “tag” to use the term of the art, of AID type. It may for example be an RFID tag, comprising the identity of the element on which it is situated, as well as optional complementary information relating to said element. This complementary information can be of alphanumeric or graphical type, and can comprise for example, in addition to the identity of the element, its weight, its dimensions, a digital photograph, or, if it is a passenger, the position of his seat in the aeroplane. For the elements of cargo type or luggage, the RFID tag can be integrated into a label stuck on the element. For passengers, their boarding card can include the RFID tag.

Said individual means of remote identification must preferably have sufficient memory to receive this various complementary information, that the device according to the invention processes and exchanges with local users, that is to say situated in the aeroplane or in immediate proximity thereto, by a display route, and/or with the ground-based computerized system SI of the operator of the aircraft V. Furthermore, mention may be made of the example of the known passports equipped with an RFID marker which contains a digital photograph of the bearer. The device according to the invention can undertake the reading of the corresponding data at the same time as the reading of the identifier of the passenger, and can display the corresponding photograph on a monitor screen for verification by the crew. It is noted that reading the passport is in this case an alternative to reading a boarding card equipped with an RFID marker. In the same manner, mention may be made of the example of using the memory of the existing markers of catering containers—“trolleys” or “galleys” as they are known—for transmitting information on their content to the crew.

It may additionally be remarked here that, preferably, the means of remote reading must be versatile, that is to say capable of reading various types of AID markers: alphanumeric, barcode, contactless marker—such as RFID—, contact-based marker—such as memory card or memory button. Moreover, so as to allow modifications of the information relating to the elements, the system according to the invention can comprise writing means compatible with the same types of AID markers.

Thus, any element entering or exiting the aircraft V through one of the accessways A1, A2, A3 is detected and identified by means of the RFID readers R1, R2, R3. It is therefore possible to ascertain in real time the identity of each of the elements belonging to the content of the aircraft V. All the information read by virtue of the means of remote reading, including R1, R2, R3, can be communicated to the computerized system SI of the operator by means, for example, of a telephonic transmitter TR, or a local radio loop such as is described in patent US2008070517 relating to the transfer of information content between an aircraft and ground-based computerized systems. A local user of the system can also access the information relating to the content of the aircraft V, or the elements entering or exiting, by way of a user interface that may be situated at the level of a control box INT or at the level of a portable AID reader. The control box INT is equipped with a screen allowing it to display text and/or images destined for the user. Moreover, the control box INT or the portable AID reader can be equipped with means of remote writing allowing the user to modify the AID or RFID tag of the elements entering or exiting the aircraft V.

The system according to the invention furthermore comprises processing units U whose function is notably to process the data gathered by the RFID readers R1, R2, R3. These processing units U can for example ensure one of the following functions:
concentrator of data originating from the RFID readers R1, R2, R3,
concentrator of data originating from the computerized system SI,
transmitter of information to the control boxes INT,
transmitter, of wireless telephony type, allowing communication with the computerized system SI.

Moreover, the system according to the invention can have lists comprising the identity of the set of elements supposed to join or leave the content of the aircraft V. The system can in this case compare the list of the elements supposed to join the content of the aircraft V with the list of the elements actually entering the aircraft V. The system can likewise compare the list of the elements supposed to leave the content of the aircraft V with the list of the elements actually exiting the aircraft V. In the event of anomaly, the system warns the user, by way for example of a user interface situated at the level of the control box INT.

The system according to the invention furthermore comprises sets of couplers CP1, CP2 and CP3, associated respectively with the RFID readers R1, R2 and R3. Each set of couplers comprises a communication coupler making it possible to ensure the communications between the various items of equipment of the system. These communication couplers can be of wired type, and in this case preferably of CPL type (the acronym standing for Communication on Power Lines). Communication couplers of this type are well known.

The sets of couplers CP1, CP2, CP3 also comprise power supply couplers. The latter draw their energy from an existing power supply or communication network in the aircraft V, this host onboard network pre-existing for another function which is itself certified to operate on the ground exclusively.

In this way, the system according to the invention does not give rise to any new complex course of action for certifying the aircraft V, said system according to the invention being powered exclusively on the ground in a certified manner through the pre-existing host network.

Moreover, the sets of couplers CP1, CP2, CP3 can utilize the physical supports of the network of the aircraft V, be it for their power supply or their communications. On the other hand, the system according to the invention preferably uses different frequency bands from those used by the host system, namely the aircraft V, both for its power supply and for its communications.

Finally, according to the chosen mode of implementation of the invention, the power supply couplers belonging to the sets of couplers CP1, CP2, CP3 of the system according to the invention can draw their energy PW from the devices for monitoring the accessways A1, A2, A3 or from power supply devices belonging for example to conveyers of containers, or any other pre-existing onboard system certified to operate on the ground exclusively.

To summarize, the invention has the main advantage of proposing a solution allowing precise knowledge, in real time, of the content of a transport aircraft, by means of a combination of commonplace and inexpensive technologies.

The invention furthermore presents the advantage of consuming little energy.

What is claimed is:

1. Onboard system for identifying and monitoring the content of an aircraft exhibiting at least one accessway, said aircraft comprising at least one pre-existing electrical device for a function other than that of the system according to the invention, making use, for its activation, of a power supply network designed and certified to be able to be powered up only when the aircraft is on the ground, said content consisting of a set of elements that can comprise objects and/or persons, each of said elements possessing an identity, said set of elements exhibiting a set of elements exiting, that is to say leaving the content of the aircraft, and a set of elements entering, that is to say joining the content of the aircraft, each of said elements comprising individual means of remote identification making it possible to ascertain the identity of said elements, said system comprising moreover:
a computerized system,
means of remote reading of said individual means of remote identification,
power supply means for said means of remote reading,
communication means,
said means of remote reading of said individual means of remote identification ensuring the acquisition of the identity of the elements entering and of the identity of the elements exiting, and communicating with the computerized system, so as to allow the ascertaining in real time of the identity of the set of the elements constituting the content of the aircraft wherein said power supply means draw their energy from said pre-existing power supply network, designed and certified so as to be able to be powered up only when the aircraft is on the ground.

2. System according to claim 1, wherein said communication means are designed to operate solely when the aircraft is on the ground.

3. System according to claim 1, wherein said communication means are of CPL type (the acronym standing for Communication on Power Lines), the physical communication channel or channels being in this case merged with the physical energy supply channel or channels.

4. System according claim 1, the aircraft comprising a pre-existing set of physical communications channels for functions other than that of the system according to the invention, and designed to be activatable only when the aircraft is on the ground, wherein said communication means of the system according to the invention use physical communication channels belonging to said pre-existing set of physical communication channels, with the exclusion of any physical communication channel.

5. System according to claim 3, the aircraft comprising a pre-existing set of physical communications channels for functions other than that of the system according to the invention, and designed to be activatable only when the aircraft is on the ground, wherein said communication means of the system according to the invention use physical communication channels belonging to said pre-existing set of physical communication channels, with the exclusion of any physical communication channel.

6. System according to any claim 1, wherein said individual means of remote identification comprise information relating to said elements.

7. System according to claim 6, comprising specific means for informing in real time a user of said system of the identity and information relating to the elements entering or to the elements exiting.

8. System according to claim 1, wherein at least one part of said communication means are non-wired.

9. System according to claim 1, wherein said individual means of remote identification are markers of AID type (the acronym standing for Automated Identification), i.e. “AID tags” as they are known in the art.

10. System according to claim 1, wherein said individual means of remote identification are RFID markers (the acronym standing for Radio-Frequency Identification), i.e. “RFID tags” as they are known in the art.

11. System according to claim 1, wherein said means of remote reading are adapted for reading one at least of the following types of AID markers: alphanumeric, barcode, contactless marker—such as RFID—, contact-based marker—such as memory card or memory button.

12. System according to claim 1, wherein said means of remote reading are RFID readers (the acronym standing for Radio-Frequency Identification).

13. System according to claim 12, wherein said RFID readers possess at least one emitting and receiving antenna able to use one at least of the following frequency bands: low frequency LF, high frequency HF and very high frequency UHF.

14. System according to claim 1, comprising a theoretical list of the elements entering comprising the identities of a set of elements assumed to have to join the content of the aircraft, and means for comparing between said theoretical list of the elements entering and said elements entering actually joining the content of the aircraft.

15. System according to claim 1, comprising a theoretical list of the elements exiting comprising the identities of a set of elements assumed to have to leave the content of the aircraft, and means for comparing between said theoretical list of the elements exiting and said elements exiting actually leaving the content of the aircraft.

16. System according to claim 14, comprising means for alerting a user of said system in the event of contradiction between the theoretical list of the elements entering and the elements entering actually joining the content of the aircraft (V).

17. System according to claim 15, comprising means for alerting a user of said system in the event of contradiction between the theoretical list of the elements exiting and the elements exiting actually leaving the content of the aircraft.

18. System according to claim 1, comprising at least one monitoring box comprising a screen making it possible to display images and texts.

19. System according to claim 1, comprising portable means of remote reading, that can comprise power supply and communication supports.

20. System according to claim 1, wherein said means of remote reading are fixed, disposed so as to form a portal at the level of at least one of the access doors of the aircraft.

21. System according to claim 1, comprising processing units ensuring one at least of the following functions:
concentrator of data originating from said means of remote reading,
concentrator of data originating from said computerized system,
transmitter of data to the environment of the system,
transmitter of data to said computerized system.

22. System according to claim 1, wherein said power supply means comprise power supply couplers.

23. System according to claim 22, wherein said power supply couplers are supplied by an energy source dedicated to the monitoring of the accessway or accessways of the aircraft.

24. System according to claim 1, wherein said power supply means use one or more frequency bands not used by the aircraft for its inherent power supply.

25. System according to claim 1, wherein said communication means use one or more frequency bands not used by the aircraft for its inherent communications.

26. System according to any one of the preceding claims, wherein said means of communications of the system according to the invention are of optical nature.

27. System according to claim 1, comprising it moreover comprises means for transmitting energy between the constituent elements of the system according to the invention, said means for transmitting energy being preferably of optical nature.

28. System according to claim 1, comprising a passenger monitoring box, notably for the passengers entering corresponding to said elements entering, and in that said passenger monitoring box indicates useful information to said passengers such as a position to be got to in the aircraft.

29. System according to claim 1, the aircraft comprising an in-flight entertainment system and passengers forming part of said content of the aircraft, said system moreover comprising a link with said in-flight entertainment system, so that said in-flight entertainment system can access the identity of the passengers, with a view to offering them customized services.

30. System according to claim 29, wherein said individual means of remote identification of the passengers entering are integrated into a boarding card.

31. System according to claim 1, wherein said means of remote reading furthermore comprise means of remote writing allowing a user of said system to modify said individual means of remote identification.

32. System according to claim 31, wherein said writing means are suited to one at least of the following AID markers: alphanumeric, barcode, contactless marker—such as RFID—, contact-based marker—such as memory card or memory button.

33. System according to claim 1, comprising means of inter-connection of said means of remote reading.
